(19) United States
(12) Patent Application Publication
(10) Pub. No.: US 2026/0113313 A1
(43) Pub. Date: Apr. 23, 2026

(54) ONE TIME PASSWORD ENCRYPTION

(71) Applicant: International Business Machines Corporation, Armonk, NY (US)

(72) Inventors: Lebohang Happy Mashatola, Germiston (ZA); Sekou Lionel Remy, Nairobi (KE)

(21) Appl. No.: 18/920,729

(22) Filed: Oct. 18, 2024

(51) Int. Cl. H04L 9/40

(52) U.S. Cl. CPC H04L 63/0838; H04L 63/0435; H04L 63/108

(57) ABSTRACT

A method, according to one approach includes: encoding an identification number into a persistence diagram. The method also includes transmitting a filtration threshold associated with the persistence diagram as a one time password (OTP) to a user device. A recreated persistence diagram is further received from the user device. The recreated persistence diagram is generated at the user device using the identification number and the filtration threshold. Moreover, in response to determining that the persistence diagram and the recreated persistence diagram are the same, access to a restricted computational system is provided. The filtration threshold is also changed in response to a predetermined period of time elapsing.

### BACKGROUND

The present invention relates to one time passwords (OTPs), and more specifically, this invention relates to using encrypted OTPs.

Data production has continued to increase, particularly as computing power and the use of IoT devices continue to advance. For instance, the rise of smart enterprise endpoints has led to large amounts of data being generated at remote locations. Data production will only further increase with the growth of 5G networks and an increased number of connected mobile devices. This issue has also become more prevalent as the complexity of machine learning models increases. Increasingly complex machine learning models translate to more intense workloads and increased strain associated with applying the models to received data.

While cloud computing has been implemented in an effort to improve the ability to process this increasing amount of data, moving sensitive data and workloads to the cloud exposes them to significant security risks. For example, the process of moving certain data and workloads to cloud for computation efficiency assumes the cloud to be secure. Cryptography allows for some security to be introduced to workloads and data that are exposed to public environments, but has also introduced unique security risks that have plagued conventional products.

For example, access to central systems that manage sensitive data and/or other protected information may be restricted unless a user is able to provide valid login credentials, e.g., such as an identification (or username) and password. However, login credentials provide limited security for the underlying information, as it is easy for a given user's login credentials to be exposed.

### SUMMARY

A method, according to one approach includes: encoding an identification number into a persistence diagram. The method also includes transmitting a filtration threshold associated with the persistence diagram as an OTP to a user device. A recreated persistence diagram is further received from the user device. The recreated persistence diagram is generated at the user device using the identification number and the filtration threshold. Moreover, in response to determining that the persistence diagram and the recreated persistence diagram are the same, access to a restricted computational system is provided. The filtration threshold is also changed in response to a predetermined period of time elapsing.

A computer program product, according to another approach, includes: one or more computer-readable storage media, and program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational view of developing a protected OTP, in accordance with one approach.

FIG. 2C is a representational view of developing a schematic representation of the persistence homology, in accordance with one approach.

FIG. 3 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods, and computer program products for improving the security of sensitive data and secure locations. Approaches herein may thereby be performed to achieve improved in-flight encryption of OTPs using topological data analysis. This desirably increases the security of OTPs that are used to provide authorization across a wide range of applications. This also increases security of the user sensitive data, particularly in comparison to conventional issues experienced by storing sensitive data with inadequate or even nonexistent protection, e.g., as will be described in further detail below.

In one general approach, a method includes: encoding an identification number into a persistence diagram. The method also includes transmitting a filtration threshold associated with the persistence diagram as an OTP to a user device. A recreated persistence diagram is further received from the user device. The recreated persistence diagram is generated at the user device using the identification number and the filtration threshold. Moreover, in response to determining that the persistence diagram and the recreated persistence diagram are the same, access to a restricted computational system is provided. The filtration threshold is also changed in response to a predetermined period of time elapsing.

In another general approach, a computer program product includes: one or more computer-readable storage media, and program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved data protection code at block 150 for improving the security of sensitive data and secure locations. Approaches herein may thereby be performed to achieve improved in-flight encryption of OTPs using topological data analysis. This desirably increases the security of OTPs that are used to provide authorization across a wide range of applications.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and IoT sensor set 125), and network module 115. Remote server 104 includes remote database 130. Public cloud 105 includes gateway 140, cloud orchestration module 141, host physical machine set 142, virtual machine set 143, and container set 144.

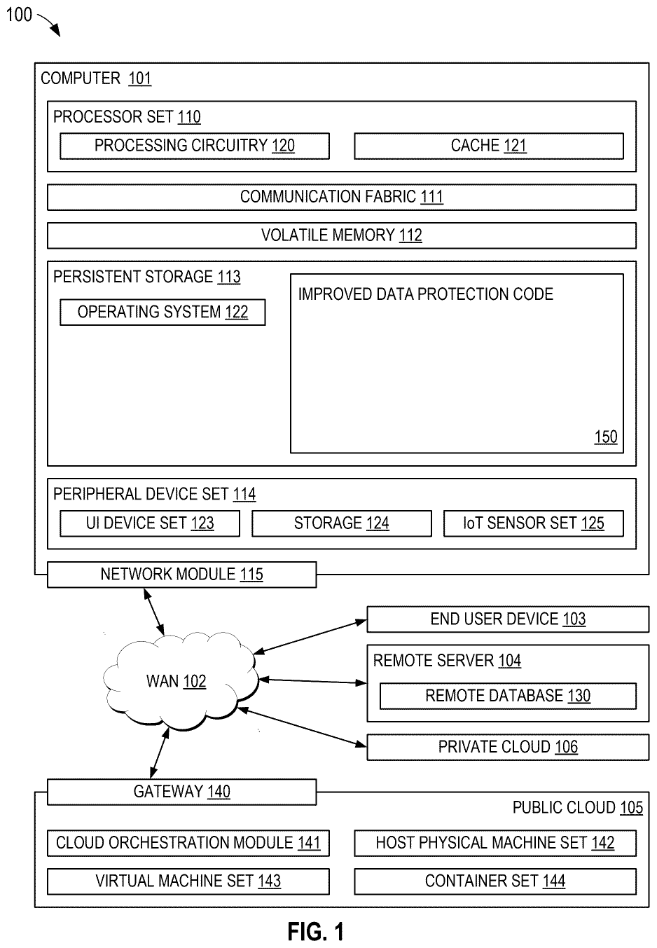

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production has continued to increase, particularly as computing power and the use of IoT devices continue to advance. For instance, the rise of smart enterprise endpoints has led to large amounts of data being generated at remote locations. Data production will only further increase with the growth of 5G networks and an increased number of connected mobile devices. This issue has also become more prevalent as the complexity of machine learning models increases. Increasingly complex machine learning models translate to more intense workloads and increased strain associated with applying the models to received data. The operation of conventional implementations has thereby been negatively impacted.

While cloud computing has been implemented in an effort to improve the ability to process this increasing amount of data, moving sensitive data and workloads to the cloud exposes them to significant security risks. For example, the process of moving certain data and workloads to cloud for computation efficiency assumes (e.g., requires) the cloud to be secure. Cryptography allows for some security to be introduced to workloads and data that are exposed to public environments, but has also introduced unique security risks that have plagued conventional products.

For example, access to central systems that manage sensitive data and/or other protected information may be restricted unless a user is able to provide valid login credentials, e.g., such as an identification (or username) and password. However, login credentials provide limited security for the underlying information, as it is easy for a given user's login credentials to be exposed. Furthermore, it is nearly impossible to determine whether a given user's login credentials have been exposed at a given point in time. While OTPs have been developed in an attempt to introduce an additional layer of security to the verification process, conventional products have still been unable to reliably thwart access attempts to sensitive data from nefarious sources.

For instance, conventional OTPs can be easily intercepted and/or phished by nefarious parties. Examples of this include fraudulent subscriber identity module (SIM) swaps and deceiving legitimate users to send OTPs to locations posing as legitimate representatives. Furthermore, OTPs are typically represented as simple 6-digit numbers which are susceptible to brute-force attacks, particularly as computing power continues to consistently improve.

In sharp contrast to these conventional shortcomings, approaches herein are desirably able to improve data security and retention by introducing additional layers of security. For instance, encrypting OTPs and other types of tokens that are vulnerable to brute-force attacks using persistence homology desirably provides additional security and allows for the OTPs to be sent securely across various different types of connections. This results in the OTP being less susceptible to brute-force attacks by increasing its complexity, thereby further reducing the risk of unauthorized access to secure locations and/or sensitive data, e.g., as will be described in further detail below.

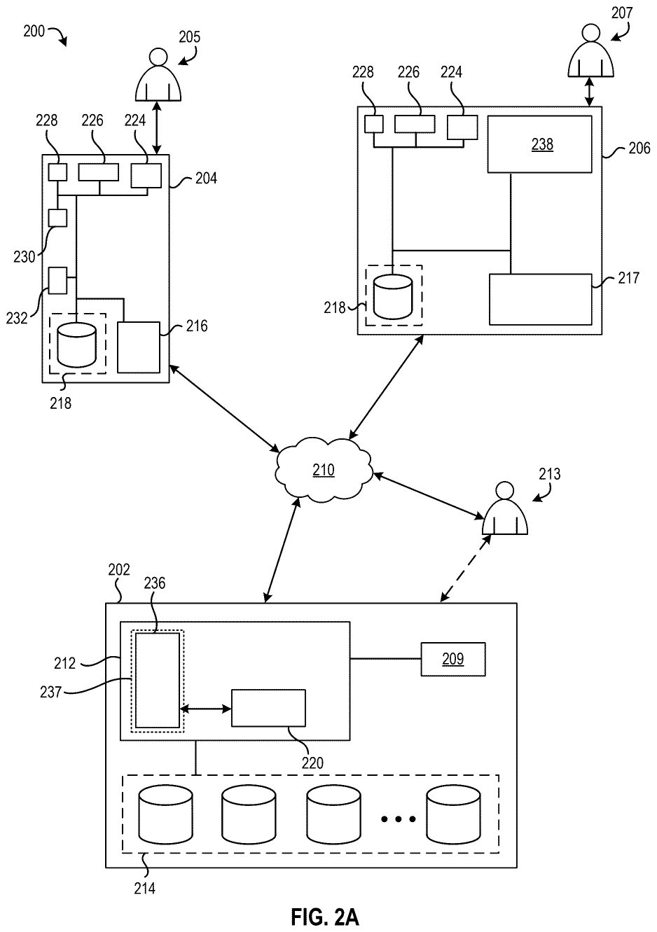

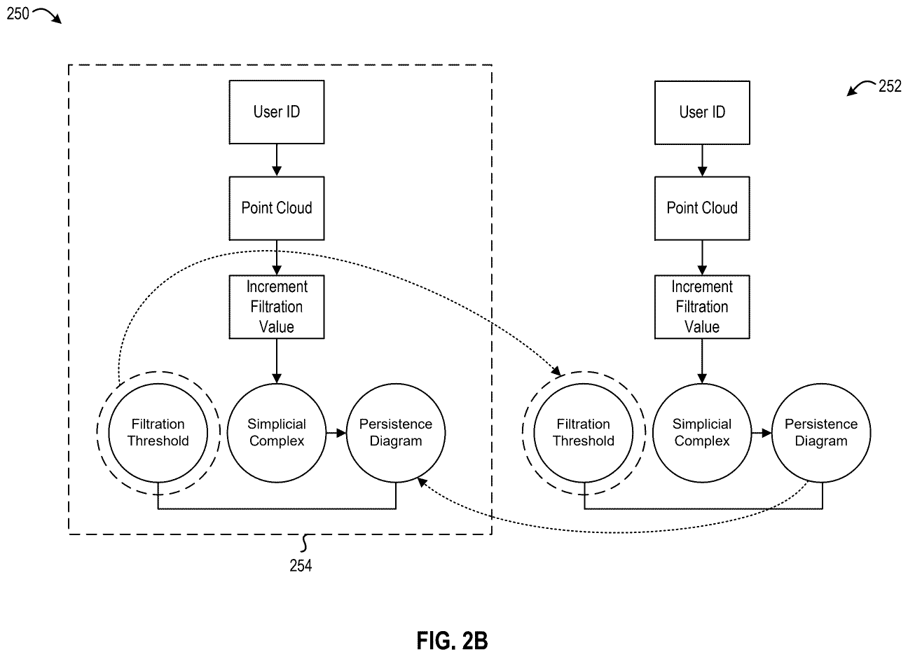

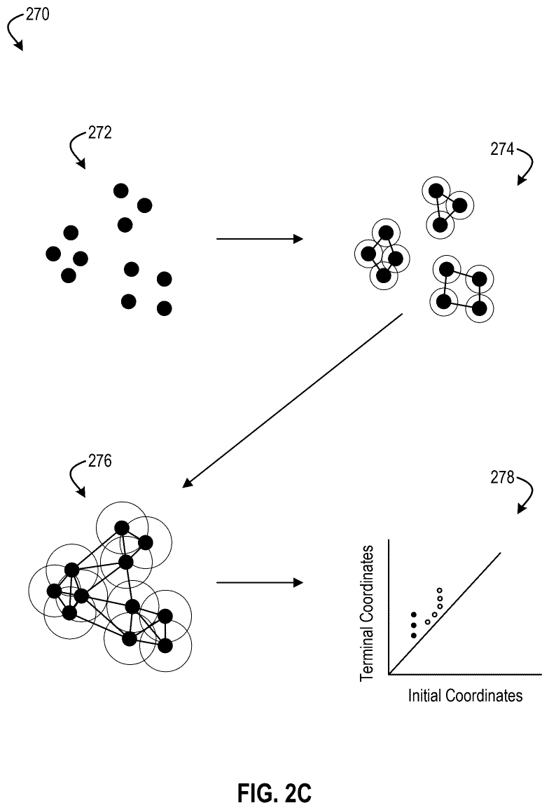

Looking now to FIG. 2A, a distributed data storage system 200 in accordance with one approach. As an option, the present system 200 may be implemented in conjunction with features from any other approach listed herein, such as those described with reference to the other FIGS. However, this distributed data storage system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the distributed data storage system 200 includes a central server 202 that is connected to user device 204 and edge node 206. Specifically, the central server 202, user device 204, and edge node 206 are connected to a network 210 that allows for data (e.g., information, commands, requests, instructions, responses, encrypted data, etc.) to be sent between any of the locations 202, 204, 206.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between the locations 202, 204, 206, regardless of the amount of separation which exists therebetween, e.g., despite being positioned at different geographical locations. It should also be noted that the different locations 202, 204, 206 may be connected to each other (and/or other locations) differently depending on the approach. According to an example, two host locations may be located relatively close to each other and connected by a wired connection, e.g., a cable, a fiber-optic link, a wire, etc.; etc., or any other type of connection which would be apparent to one skilled in the art after reading the present description.

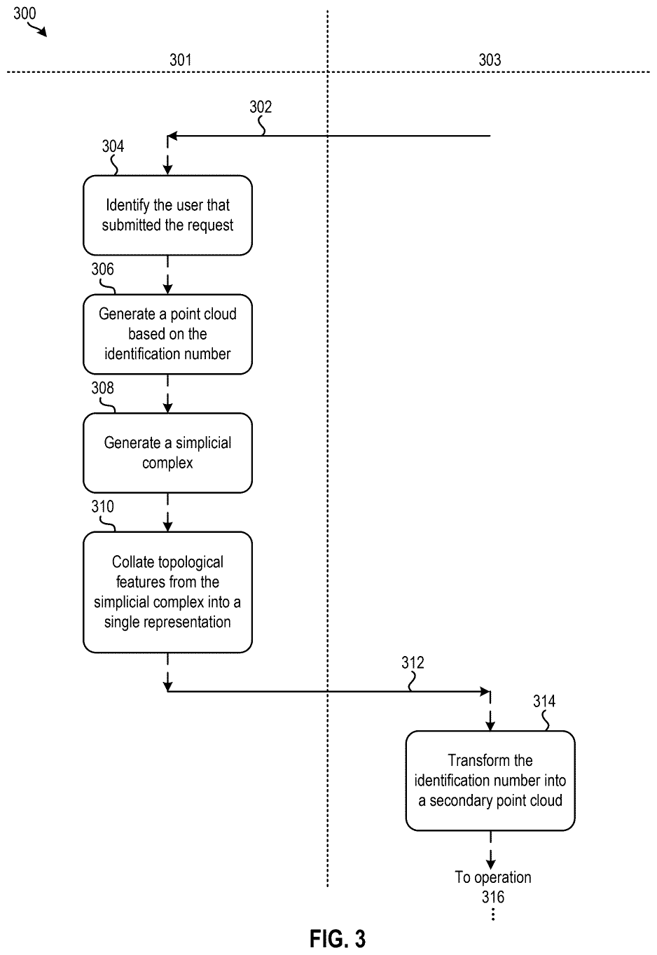

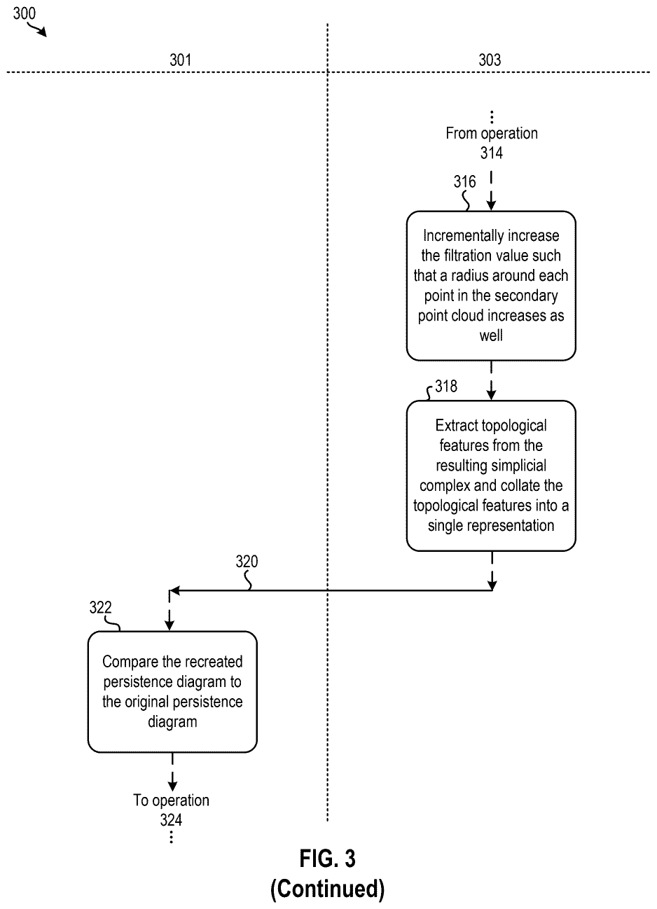

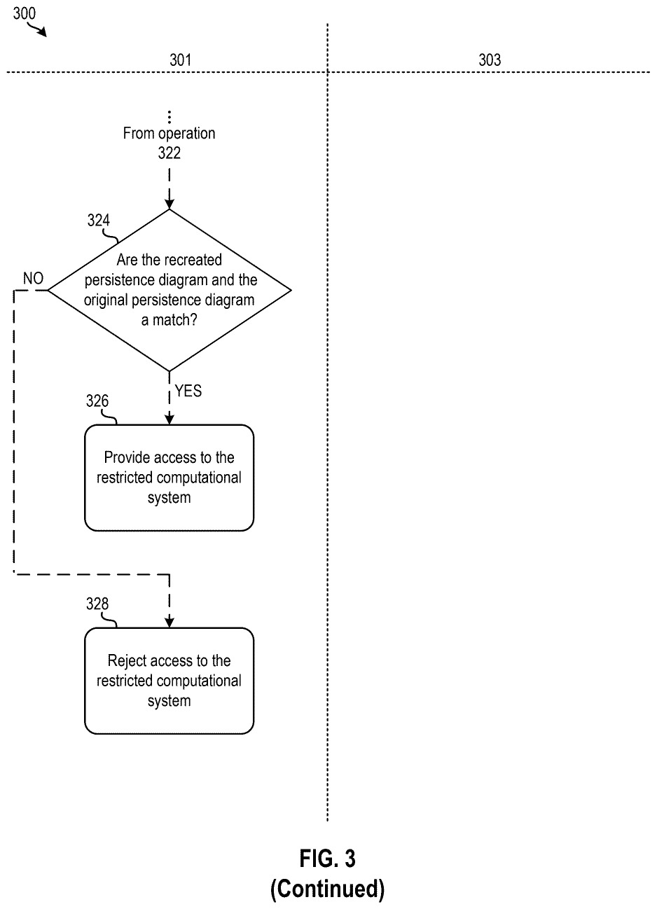

With continued reference to FIG. 2A, the central server 202 includes a large (e.g., robust) processor 212 coupled to a cache 209 and memory 214 having a relatively high storage capacity. The central server 202 is thereby able to process and store a relatively large amount of data, allowing it to be connected to, and manage, multiple different remote locations. Moreover, in some approaches the central server 202 may generate or receive OTPs for each supported user that requests access to the central server 202 and/or protected portions thereof. For instance, secure engine 220 may generate OTPs for users attempting to access a secure software environment (e.g., see secure software environment 236). In some approaches, the secure engine 220 generates an OTP for a user in response to the user providing a verifiable identification (ID) and password. The central server 202 may thereby protect (e.g., encrypt) the OTP and transmit it to the respective user over network 210. In response to the user returning the verified OTP, the user may be provided access to the secure software environment 236. It follows that the secure engine 220 and/or other portions of the central processor 212 may be used to perform one or more operations in method 300 of FIG. 3 below.

Referring momentarily now to FIG. 2B, the process 250 of developing a protected OTP for a user attempting to access sensitive data and/or a secure location is illustrated in accordance with one approach. The process 250 in FIG. 2B also depicts the user confirming the OTP and returning a persistence diagram that is used to verify whether the user should be given access to the sensitive data and/or secure location, in accordance with one approach. As an option, the present process 250 may be implemented in conjunction with features from any other approach listed herein, such as those described with reference to the other FIGS. However, this process 250 and others presented herein may be used in various applications and/or in permutations which may or may not be specifically described in the illustrative approaches or implementations listed herein. Further, the process 250 presented herein may be used in any desired environment. Thus FIG. 2B (and the other FIGS.) may be deemed to include any possible permutation.

The process 250 in FIG. 2B may be initiated in response to a user 252 attempting to access sensitive data and/or other protected information that is located in a secure system 254. For example, an access request may be received at a central storage location from a user attempting to access encrypted data, a secure software environment, etc. It should be noted that the term “sensitive data” as used herein refers to information for which access is to be restricted and/or controlled in some way. For instance, a sensitive data may be used in processes that are susceptible to cyberattacks, e.g., such as a password authentication process on a computer system. Depending on the approach, sensitive data may include confidential data, data that is to remain within an organization and not shared outside the organization, data that is not to be made available to the public, data that a user wishes to keep private, data that is subject to a higher standard of care as a result of applicable legislation and/or corporate policies (e.g., data associated with children under 13 years of age as specified by the Children's Online Privacy Protection Act), data that is provided confidentially to another user or entity, etc. In some approaches, certain computing tasks and/or applications are designated by a user, application developer, system administrator, etc., as sensitive tasks that utilize sensitive data.

In response to receiving the user request, the process 250 identifies the user that the request was received from. For instance, the user may be identified with a User ID. The User ID may be received directly from the user along with the request in some approaches. In other approaches, a list of known User ID s may be stored in a repository which is referenced to identify a user attempting to access a secure system.

In response to identifying the User ID associated with a received access request, the User ID is converted into a Point Cloud. In other words, the User ID is converted into a plurality of values that are arranged into a Point Cloud. The points in the Point Cloud thereby serve as a one-dimensional (1D) representation of the User ID. It follows that this process effectively converts the User ID from a value to a spatial representation. In some approaches, the User ID is converted into the Point Cloud using a 1D to two-dimensional (2D) mapping function.

In response to forming the Point Cloud, a Filtration Value for the points in the Point Cloud is set to an initial value and incremented over time. This causes each of the points in the Point Cloud to develop a ring (e.g., halo) that expands as the Filtration Value increases, thereby beginning to develop a simplicial complex. Thus, as the Filtration Value is incremented, radii of the rings around the various points continue to increase, developing the details included in the simplicial complex. As the various radii continue to increase, they create new connections with adjacent points and their respective rings. However, these connections (e.g., relationships) between the various points and their rings also fade out of existence as the rings continue to grow.

These relationships between the various points and rings that are created and terminated over time may be represented by various topological features. For instance, topological features may represent (e.g., indicate) a number of connected points in the simplicial complex, a number of cycles and/or loops in the simplicial complex, a number of three dimensional holes in the simplicial complex, etc.

In response to reaching a filtration threshold, the filtration value may no longer be incremented. In other words, the simplicial complex may be complete upon reaching the filtration threshold. The filtration threshold may be predetermined by a user, one or more running applications, one or more AI based models, etc. It should also be noted that the filtration threshold preferably changes over time. For example, the filtration threshold may be changed to a randomly selected number from a predetermined range, changed to a number specified in a predetermined list, changed to a number selected by an administrator, changed to a number based on a previously evaluated user access request, etc. The filtration threshold may also be changed at random, periodically, in response to receiving a request to do so, in response to a predetermined performance condition being met, etc. Changing the filtration threshold desirably adds additional layers of protection for the underlying sensitive data and secure location.

The topological features that are included in the simplicial complex may be represented using initial coordinates and terminal coordinates that represent when the respective features existed in the simplicial complex, e.g., as would be appreciated by one skilled in the art after reading the present description. The initial and terminal coordinates for each topological feature may thereby be plotted on a persistence diagram. In some approaches, the simplicial complex and corresponding coordinates may be converted into a persistence diagram using persistence homology.

According to an example, which is in no way intended to be limiting, FIG. 2C illustrates the process 270 of converting a starting point cloud into a simplicial complex, and ultimately a persistence diagram. In other words, the process 270 involves developing a schematic representation of the persistence homology, including generating the point cloud, building the simplicial complex by incremental increasing of the filtration. Subsequently, topological features are collated into a single representation, e.g., such as a persistence diagram. It follows that the persistence diagram collates the topological features with corresponding coordinates.

It follows that the operations illustrated in FIG. 2C may be implemented in conjunction with features from any other approach listed herein, such as those described with reference to the other FIGS. However, this process 270 and others presented herein may be used in various applications and/or in permutations which may or may not be specifically described in the illustrative approaches or implementations listed herein. Further, the process 270 presented herein may be used in any desired environment. Thus FIG. 2C (and the other FIGS.) may be deemed to include any possible permutation.

As shown, the point cloud includes a plurality of points formed in operation 272 by converting a starting value (e.g., user ID) into a number of components. However, operation 274 includes setting (e.g., initiating) a persistence value at an initial value and beginning to increment the persistence value. As shown, incrementing the persistence value causes rings to develop around each of the points in the point clouds, thereby beginning to convert the points into a more detailed representation of the complex relationships between the various points. Operation 274 also shows how as the rings expand, they come into contact with other rings and/or points in the representation.

Advancing to operation 276, the persistence value has reached a persistence threshold, indicating that the incrementing is ended. The points and corresponding rings have thereby reached a final state in the simplicial complex. Moreover, operation 278 includes collating topological features from the simplicial complex into a graphical representation. As noted above, topological features include initial coordinates and terminal coordinates that represent when the respective features existed in the simplicial complex. The initial and terminal coordinates for each topological feature may thereby be plotted on a persistence diagram, e.g., as seen in operation 278. In some approaches, the simplicial complex and corresponding coordinates may be converted into a persistence diagram using persistence homology.

Persistence diagrams as referred to herein may be depicted in a number of different ways depending on the approach. For instance, some approaches include one or more colors, crosshatchings, tags, comments, etc., or other details that are represented in the persistence diagrams. According to a non-limiting example, colors that are presented in a persistence diagram correspond to respective Betti numbers that may be used in an attempt to present various details about the information available in the persistence homology. For example, a first of the Betti numbers may correspond to (e.g., represents) a number of connected points in the persistence diagram. Moreover, a second of the Betti numbers may correspond to a number of cycles and/or loops in the persistence diagram. Furthermore, a third of the Betti numbers may correspond to a number of three dimensional (3D) holes in the persistence diagram.

Referring back now to FIG. 2B, the secure system 254 preferably encrypts the filtration threshold used to form the simplicial complex and persistence diagram in response to the persistence diagram being formed. The encrypted filtration value serves as a private key that is converted into an OTP in the present approach and sent to the user location 252. In response to receiving the OTP, the user 252 decrypts the encrypted filtration threshold. In some approaches, the filtration threshold is encrypted using the User ID that corresponds to user 252. Accordingly, the user 252 is able to decrypt the filtration threshold using their User ID. However, the filtration threshold may be encrypted differently depending on the approach and may thereby be decrypted using processes that would be apparent to one skilled in the art after reading the present description.

In response to obtaining the decrypted filtration threshold, the User ID assigned to user 252 is converted into a Point Cloud, e.g., as mentioned above. While the Point Cloud originally includes only the points derived from the User ID, the filtration value is incremented over a period of time, causing rings to develop around the points and expand over time in a simplicial complex, e.g., as described above. In response to reaching the filtration threshold, the simplicial complex is converted into a persistence diagram which is ultimately returned to the secure system 254, e.g., as a shared key. In response to receiving the persistence diagram reproduced by user 252, the secure system 254 compares the reproduced persistence diagram to the persistence diagram originally created at the secure system. In situations where the same User ID was used to create the starting Point Clouds, and assuming the same filtration threshold is observed, the resulting persistence diagrams will match. Comparing the two persistence diagrams thereby provides an easy and clear way to determine whether the user 252 is actually authorized to access the secure system 254.

It follows that FIG. 2B outlines the OTP encryption framework for a preferred approach. There, the system encodes an identification number into a persistence diagram, and the filtration value is encrypted into an OTP before being sent to the user. The user receives the OTP and decrypts the OTP constructing the persistence diagram by matching filtration value to construct a matching persistence diagram. The persistence diagram in the form of a multi-set (i.e. a collection of initial and terminal coordinates for each topological feature in the persistence diagram) is sent to the system for evaluation to test for an ideal (e.g., exact) match. Time-based recalculation of the filtration value is performed also preferably performed to maintain data security and retention.

Referring back now to FIG. 2A, the secure software environment 236 may be designed (e.g., custom built) to have certain characteristics and/or functionality. For instance, the secure software environment 236 may be used to generate and/or store at least some of the OTPs that are sent to the respective authorized users. The secure software environment 236 may also be modified as desired, e.g., to apply one or more encryption keys to the OTPs, decrypt encrypted information received from the users, add trusted (compliant) hashing algorithm details, etc. In some approaches, the secure software environment is a plugin-based software package that is modified by a host and sent to central server 202 for implementation. For instance, the processor 212 may use the secure software environment 236 to process incoming user requests to access sensitive data and/or secure locations. However, the secure software environment 236 may only be accessed by a secure engine 220, and is inaccessible to a remainder of the processor 212. In other words, a logical boundary 237 may only be crossed by secure engine 220, and the logical boundary 237 prevents any other aspects of the processor 212 from accessing the secure software environment 236 and any information therein. Software being run outside the logical boundary 237—other than any software running in the secure engine 220—is thereby unable to directly access any data being processed by software running in the secure software environment 236.

The ability to insulate the secure software environment 236 from exterior access effectively hides any sensitive information, data, etc., that is sent to and/or generated at the secure software environment 236. Thus, although the secure software environment 236 is located at the central server 202, it may implement confidential details without exposing them to the central server 202 and/or entities connected thereto, e.g., such as administrator 213. Any sensitive data and/or secure logical locations that are located in the secure software environment 236 may thereby be protected against nefarious access attempts, e.g., as will be described in further detail below.

With continued reference to FIG. 2A, user device 204 may be a mobile phone that includes a processor 216 coupled to memory 218. The processor 216 may receive inputs from, and interface with, user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc.

Moreover, edge node 206 includes some of the same or similar components as those included in other locations of system 200, and have therefore been given corresponding numbering. For instance, controller 217 is coupled to memory 218, a display screen 224, keys of a computer keyboard 226, and a computer mouse 228, which are accessible to administrator 207, e.g., at a built-in computer terminal for the edge node 206. Additionally, the controller 217 is coupled to an AI module 238. The AI module 238 may include any desired number and/or type of AI-based models, e.g., such as machine learning models, deep learning models, neural networks, etc. Moreover, the models may be trained to evaluate user requests to access sensitive data and/or secure locations, generate protected (e.g., encrypted) OTPs for authorized users, and verify information received from the users in response to the respective OTPs, e.g., as would be appreciated by one skilled in the art after reading the present description.

The edge node 206 itself may include a secure software environment in some approaches. For example, the controller 217 may include a secure software environment therein that generates and/or monitors OTPs that are sent to authorized users that are able to provide verified credentials (e.g., user ID and password). In some approaches, the AI module 238, controller 217, and/or a secure software environment (not shown) in the edge node 206 may be used to perform one or more operations in method 300 of FIG. 3 below.

Looking now to FIG. 3, a flowchart of a method 300 for improving the security of sensitive data in accordance with one approach. One or more of the operations in method 300 may thereby be performed to achieve improved in-flight encryption of OTPs using topological data analysis. This desirably increases the security of OTPs that are used to provide authorization across a wide range of applications. This also increases security of the user sensitive data, particularly in comparison to conventional issues experienced by storing sensitive data with inadequate or even nonexistent protection, e.g., as will be described in further detail below.

Each of the steps of the method 300 may be performed by any suitable component of the operating environment. For example, both of the nodes 301, 303 shown in the flowchart of method 300 may correspond to one or more processors positioned at a different location in a distributed system. Moreover, each of the one or more processors are preferably configured to communicate with each other.

In various embodiments, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3 includes different nodes 301, 303, each of which represent one or more processors, controllers, computer, etc., positioned at a different location in a distributed system. For instance, node 301 may include one or more processors which are electrically coupled to a central compute location of a distributed system (e.g., see central server 202 of FIG. 2A above). Node 303 may include one or more processors which are electrically coupled to a user location (e.g., user device) that is connected to the distributed system (e.g., see user device 204 of FIG. 2A above). Accordingly, commands, data, requests, etc. may be sent between the nodes 301, 303 depending on the approach. Moreover, it should be noted that the various processes included in method 300 are in no way intended to be limiting, e.g., as would be appreciated by one skilled in the art after reading the present description. For instance, data sent from node 301 to node 303 may be prefaced by a request sent from node 303 to node 301 in some approaches.

As shown, operation 302 of method 300 includes receiving a request from a user to access sensitive data in a secure location. Moreover, operation 304 includes identifying the user that submitted the request. In some approaches, the request is received along with information that may be used to identify the user that submitted it. For instance, a unique user ID of the user may be received along with the request in some approaches. In other approaches, the user may provide identifying information (e.g., specific location information, Internet Protocol (IP) information, etc., that may be used to derive a known user ID that corresponds to the user that submitted the request. In still other approaches, the request may be received along a communication path that is dedicated to a given user, thereby allowing for the user ID to be deduced without any supplemental information being received.

In response to receiving the access request and identifying the user that submitted the request, the user identifying number (e.g., user ID) is encoded into a persistence diagram. This effectively encodes the identifying number into a shape that adds complexity and ultimately improves security of the underlying data and/or secure system. Thus, method 300 advances from operation 304 to operation 306. There, operation 306 includes generating a point cloud based on the identification number. In some approaches, the identification number is converted into a point cloud using a 1D to 2D mapping function. According to an example, which is in no way intended to be limiting, a 1D to 2D mapping can be determined by using the following transformation.

$$i = x + width * y$$

Here, the “width” denotes the dimensionality of the array, while “x” provides a corresponding value in the x-direction and “y” represents a value in the y-direction. Furthermore, the value “i” denotes the index of the value in the 1D representation. It follows that each value in the identification number represents “i”, while the width is a constant value. The values for x and y can also be determined for each value of “i”, e.g., to build a 2D array. This techniques implements aspects of storing pixels in memory, where each pixel coordinate (x,y) is converted into to single digits (e.g., solving for i).

From operation 306, method 300 advances to operation 308. There, operation 308 includes generating a simplicial complex. As noted above, a simplicial complex may be formed by increasing the filtration value incrementally until reaching a filtration threshold. In other words, a counter may be incremented until it reaches the filtration threshold, thereby allowing the rings in the simplicial complex to reach a desired extent of expansion. In response to reaching the filtration threshold, method 300 advances from operation 308 to operation 310. There, operation 310 includes collating topological features from the simplicial complex into a single representation. In other words, the relationships between the various points and their respective rings in the simplicial complex are merged into a single representation. In preferred approaches, the “single representation” includes a persistence diagram (e.g., see operation 278 of FIG. 2C). In some approaches, the simplicial complex and corresponding coordinates may be converted into a persistence diagram using persistence homology. In the persistence diagram, each of the topological features may be represented (e.g., plotted) using the corresponding initial coordinates and terminal coordinates which indicate a period that the respective features were present in the simplicial complex, e.g., as described above.

With continued reference to FIG. 3, method 300 advances from operation 310 to operation 312. There, operation 312 includes transmitting the filtration threshold used to form the simplicial complex and associated persistence diagram as an OTP to the user that submitted the request received in operation 302. In other words, operation 312 includes sharing the filtration threshold with the user that submitted the request. As noted above, the filtration threshold effectively controls how large the rings in the simplicial complex grow. Similarly, the increments by which the filtration value are incremented before reaching the filtration threshold may also impact the resulting topological features and final persistence diagram. The filtration threshold effectively serves as a private key in verifying a user attempting to access a secure location. Thus, by protecting (e.g., encrypting) the filtration threshold and applying it to the same base user identification while generating a simplicial complex at both the requesting location (e.g., user location) and target location (secure system the user is attempting to access), the resulting persistence diagrams can be used to determine whether the requesting user is authorized to access the secure location, e.g., as would be appreciated by one skilled in the art after reading the present description.

In response to receiving the filtration threshold at node 303, method 300 advances to operation 314. There, operation 314 includes transforming the identification number that corresponds to the user at node 303, into a secondary point cloud. In other words, the ID of the user associated with node 303 is converted into a secondary point cloud at the user location. In some approaches, the secondary point cloud may be formed using a 1D to 2D mapping function.

From operation 314, method 300 advances to operation 316. There, operation 316 includes incrementally increasing the filtration value such that a radius around each point in the secondary point cloud increases as well. As noted above, as the filtration value increases, rings around each point in the secondary point cloud increase in a similar fashion. As these rings increase over time, they come into contact with other rings and points, thereby forming topological features, thereby forming a simplicial complex. It follows that operation 316 includes incrementing the filtration value until reaching the filtration threshold received from node 301.

In response to the filtration value reaching the filtration threshold, topological features in the resulting simplicial complex are preferably extracted and collated into a single representation. See operation 318. In other words, the relationships between the various points and their respective rings in the simplicial complex at node 303 are merged into a recreated persistence diagram (e.g., see operation 278 of FIG. 2C). Moreover, proceeding to operation 320, the recreated persistence diagram is transmitted back to node 301.

In response to receiving the recreated persistence diagram from node 303, method 300 advances to operation 322. There, operation 322 includes comparing the recreated persistence diagram to the original persistence diagram created in operation 310. Moreover, operation 324 includes determining whether the recreated persistence diagram and the original persistence diagram are a match. In other words, operation 324 determines whether the two persistence diagrams are exact copies (or at least contain a number of differences that are within a predetermined tolerance) of each other. As noted above, matching copies of persistence diagrams indicate that the same filtration values were applied to the same user ID while observing the same filtration threshold. Again, by protecting the filtration threshold, it effectively serves as a private key that can be used to determine whether users are actually verified to access a protected location.

In response to determining that the persistence diagram and the recreated persistence diagram are the same, method 300 advances from operation 324 to operation 326. There, operation 326 includes providing access to the restricted computational system. In other words, operation 326 permits the user that submitted the initial request in operation 302, to access the intended secure location. Again, access to the secure location is granted in response to confirming the requesting user is authorized to do so. However, returning to operation 324, method 300 alternatively advances to operation 328 in response to determining that the persistence diagram and the recreated persistence diagram are not the same. There, operation 328 includes rejecting access to the restricted computational system. In other words, operation 328 includes rejecting the access request.

It should also be noted that the filtration threshold may be changed periodically over time. This reduces the chances of an active filtration threshold being exposed and compromising access to secure locations having sensitive (e.g., protected) information therein. The filtration threshold may be changed automatically in response to reaching a predetermined time of day, in response to a predetermined number of user requests being processed, in response to a predetermined number of users being actively connected to the secure location, etc. Thus, in some approaches the filtration threshold is actively changed in response to a predetermined period (e.g., amount) of time elapsing.

Again, approaches herein are desirably able to improve data security and retention by introducing additional layers of security. For instance, encrypting OTPs and other types of tokens that are vulnerable to brute-force attacks using persistence homology desirably provides additional security and allows for the OTPs to be sent securely across various different types of connections. This results in the OTP being less susceptible to brute-force attacks by increasing its complexity, thereby further reducing the risk of unauthorized access to secure locations and/or sensitive data.

In other words, using topological data analysis to encode a user ID (e.g., password or private key) into a physical shape will add complexity to the resulting OTP. As described herein, topological data analysis revolves around drawing out topological features from different sub-level of a simplicial complex. Moreover, these sub-levels of the simplicial complex are determined by the filtration threshold that is used to determine the number of connected edges between data points in a point cloud. Persistence homology further allows for the collation of identified topological features from the simplicial complex. As noted above, these topological features can be classified into homology groups denoted by Betti-numbers. For example, Betti-0 counts the number of connected points, Betti-1 counts the number of cycles and loops, and Betti-2 counts the number of three-dimensional holes. The topological features are also preferably summarized into persistence diagrams. Persistent diagrams are thereby used to simplify the identified invariants into a single graph. These graphs highlight the initial and terminal coordinates at which each of the invariants arise and disappear.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A method, comprising:
encoding an identification number into a persistence diagram;
transmitting a filtration threshold associated with the persistence diagram as a one time password (OTP) to a user device;
receiving, from the user device, a recreated persistence diagram, wherein the recreated persistence diagram is generated at the user device using the identification number and the filtration threshold;
in response to determining that the persistence diagram and the recreated persistence diagram are the same, providing access to a restricted computational system; and
in response to an elapsed predetermined period of time, changing the filtration threshold.

2. The method of claim 1, wherein the transmitting the filtration threshold to the user device includes:
encrypting the filtration threshold; and
transmitting the encrypted filtration threshold to the user device.

3. The method of claim 2, wherein the encoding the identification number into the persistence diagram comprises:
generating a point cloud based on the identification number;
generating a simplicial complex by observing the filtration threshold; and
collating topological features from the simplicial complex into a single representation, the topological features including initial coordinates and terminal coordinates.

4. The method of claim 3, wherein respective colors in the persistence diagram correspond to respective Betti numbers.

5. The method of claim 4, wherein a first of the Betti numbers corresponds to a number of connected points in the persistence diagram, wherein a second of the Betti numbers corresponds to a number of cycles and/or loops in the persistence diagram, wherein a third of the Betti numbers corresponds to a number of three dimensional holes in the persistence diagram.

6. The method of claim 1, wherein the recreated persistence diagram is generated at the user device by:
transforming the identification number into a secondary point cloud using a one-dimension to two-dimension mapping function;
incrementally increasing a radius around each point in the secondary point cloud along with the filtration value; and
in response to the filtration value reaching the filtration threshold, producing the recreated persistence diagram.

7. The method of claim 1, further comprising:
in response to determining that the persistence diagram and the recreated persistence diagram are not the same, rejecting access to the restricted computational system.

8. The method of claim 1, wherein the method is performed at a central server that is connected to the user device over one or more networks.

9. A computer program product, comprising:
one or more computer-readable storage media; and
program instructions stored on the one or more storage media to perform operations comprising:
encoding an identification number into a persistence diagram;
transmitting a filtration threshold associated with the persistence diagram as a one time password (OTP) to a user device;
receiving, from the user device, a recreated persistence diagram, wherein the recreated persistence diagram is generated at the user device using the identification number and the filtration threshold;
in response to determining that the persistence diagram and the recreated persistence diagram are the same, providing access to a restricted computational system; and
in response to an elapsed predetermined period of time, changing the filtration threshold.

10. The computer program product of claim 9, wherein the transmitting the filtration threshold to the user device includes:
encrypting the filtration threshold; and
transmitting the encrypted filtration threshold to the user device.

11. The computer program product of claim 10, wherein the encoding the identification number into the persistence diagram comprises:
generating a point cloud based on the identification number;
generating a simplicial complex by observing the filtration threshold; and
collating topological features from the simplicial complex into a single representation, the topological features including initial coordinates and terminal coordinates.

12. The computer program product of claim 11, wherein respective colors in the persistence diagram correspond to respective Betti numbers.

13. The computer program product of claim 12, wherein a first of the Betti numbers corresponds to a number of connected points in the persistence diagram, wherein a second of the Betti numbers corresponds to a number of cycles and/or loops in the persistence diagram, wherein a third of the Betti numbers corresponds to a number of three dimensional holes in the persistence diagram.

14. The computer program product of claim 9, wherein the recreated persistence diagram is generated at the user device by:
transforming the identification number into a secondary point cloud using a one-dimension to two-dimension mapping function;
incrementally increasing a radius around each point in the secondary point cloud along with the filtration value; and
in response to the filtration value reaching the filtration threshold, producing the recreated persistence diagram.

15. The computer program product of claim 9, wherein the operations further comprise:
in response to determining that the persistence diagram and the recreated persistence diagram are not the same, rejecting access to the restricted computational system.

16. The computer program product of claim 9, wherein the operations are performed at a central server that is connected to the user device over one or more networks.

17. A computer system, comprising:
a processor set;
one or more computer-readable storage media; and
program instructions stored on the one or more storage media to cause the processor set to perform operations comprising:
encoding an identification number into a persistence diagram;
transmitting a filtration threshold associated with the persistence diagram as a one time password (OTP) to a user device;
receiving, from the user device, a recreated persistence diagram, wherein the recreated persistence diagram is generated at the user device using the identification number and the filtration threshold;
in response to determining that the persistence diagram and the recreated persistence diagram are the same, providing access to a restricted computational system; and
in response to an elapsed predetermined period of time, changing the filtration threshold.

18. The computer system of claim 17, wherein the encoding the identification number into the persistence diagram comprises:
generating a point cloud based on the identification number;
generating a simplicial complex by observing the filtration threshold; and
collating topological features from the simplicial complex into a single representation, the topological features including initial coordinates and terminal coordinates.

19. The computer system of claim 18, wherein the topological features represent: a number of connected points in the persistence diagram, a number of cycles and/or loops in the persistence diagram, and a number of three dimensional holes in the persistence diagram.

20. The computer system of claim 17, wherein the recreated persistence diagram is generated at the user device by:
transforming the identification number into a secondary point cloud using a one-dimension to two-dimension mapping function;
incrementally increasing a radius around each point in the secondary point cloud along with the filtration value; and
in response to the filtration value reaching the filtration threshold, producing the recreated persistence diagram.
